(19) United States
(12) Patent Application Publication
(10) Pub. No.: US 2014/0360641 A1
(43) Pub. Date: Dec. 11, 2014

(54) TIRE TREAD WITH ANGLED RIB GROOVE WALLS

(71) Applicant: Jeremy J. Jacobs, Findlay, OH (US)

(72) Inventor: Jeremy J. Jacobs, Findlay, OH (US)

(73) Assignee: COOPER TIRE & RUBBER COMPANY, Findlay, OH (US)

(21) Appl. No.: 14/049,675

(22) Filed: Oct. 9, 2013

Related U.S. Application Data
(63) Continuation-in-part of application No. 29/456,929, filed on Jun. 5, 2013.

(51) Int. Cl. B60C 11/13

(52) U.S. Cl. CPC B60C 11/1307; B60C 2011/1338; B60C 2011/133
USPC 152/209.21

(57) ABSTRACT

A pneumatic tire includes first and second laterally spaced sides, and a tread interposed between the sides. The tread includes a tread surface having at least one groove. The groove includes first and second facing sidewalls separated by a groove bottom surface. A series of serrations or ribs extend over at least a portion of a height of the facing sidewalls. The serrations extend at a non-perpendicular angle relative to the tread surface and the serrations/ribs on the first and second sidewalls of the groove are opposed to each other.

### BACKGROUND

This continuation-in-part application claims the priority benefit of commonly owned, co-pending U.S. design application Ser. No. 29/456,929, filed Jun. 5, 2013, the disclosure of which is expressly incorporated herein by reference.

The present disclosure relates to an automotive tire, and specifically to the tread thereof. It finds application in conjunction with tire that exhibits improved handling, improved wet and snow traction, and reduced noise generation, and will be described with reference to a tire that is particularly useful in snow. However, it is to be appreciated that the present exemplary embodiment is also amenable to other like applications, and that may use one or more of the predicted performance benefits.

Commonly owned U.S. Pat. No. 6,986,372—Below discloses a tire in which at least selected grooves have serrated sidewalls. Specifically, all or a major portion of the surface of the sidewalls facing the groove includes these serrations. The serrations terminate short of a groove base or bottom surface. This arrangement of serrated sidewalls provides for improved traction, handling characteristics, control, as well as improved braking of the vehicle as described in the '372 patent.

Although the tire described in the above-noted patent has met with commercial success, there is always a need for improved performance such as traction, noise, handling, control, braking, etc., and particularly in connection with improved performance in snow.

### BRIEF DESCRIPTION

A pneumatic tire includes first and second laterally spaced sides. A tread is interposed between the first and second sides, and includes a tread surface having at least one groove. The groove includes facing, first and second sidewalls separated by a groove bottom surface. Serrations or ribs extend over at least a portion of each of the first and second sidewalls. The ribs on at least one of the first and second sidewalls extend at a non-perpendicular angle relative to the tread surface. In addition, the ribs on the first and second sidewalls of the groove are opposed to each other.

In an exemplary embodiment, the ribs on both of the first and second sidewalls extend at a non-perpendicular angle relative to the tread surface.

The at least one groove extends in a substantially circumferential direction around the tire, or in a substantially lateral direction across the tire.

The ribs on at least one of the first and second sidewalls extend over only a portion thereof, and in one arrangement extend over only a portion of each of the first and second sidewalls.

The at least one groove in an exemplary arrangement includes one of first and second inner grooves forming a central tread block separated from first and second intermediate tread blocks by the inner grooves that extend in a substantially circumferential direction around the tire.

The first and second intermediate tread blocks are spaced from first and second shoulder tread blocks by first and second outer grooves extending in a substantially circumferential direction around the tire, and the first and second outer grooves are interposed between the first and second inner grooves and the first and second sides of the tire, respectively.

In an embodiment of the disclosure, the ribs are also provided in the first and second outer grooves.

In one exemplary embodiment, the ribs are generally defined by alternating peaks and valleys, and extend inwardly from the ground engaging tread surface toward the bottom surface of the groove.

In one arrangement, the first and second intermediate tread blocks include ribs only on sidewalls that extend in a substantially circumferential direction around the tire, and sidewalls forming lateral grooves of the intermediate tread blocks are devoid of ribs.

In another arrangement, the central tread block includes lateral grooves that extend in a substantially lateral direction across the tire, and sidewalls forming the lateral grooves of the central tread blocks have ribs extending along at least a major portion thereof.

A tire that includes the angled rib snow groove illustrates improved performance.

The angled ribs exhibit improved grabbing and holding the snow in the tread pattern for increased “snow on snow” traction.

The angled ribs provide increased surface area length than prior arrangements, which results in better mechanical locking with the snow rib that is formed when the angled rib snow grooves are in a snow-filled contact patch.

The amount of snow traction may also increase from the mechanical shearing of the snow ribs formed in the angled rib snow grooves within the contact patch.

Providing the angled ribs in the grooves may prevent standing waves from forming and thereby reduce generated noise.

Still other benefits and advantages of the present disclosure will become more apparent from reading and understanding the following detailed description.

### BRIEF DESCRIPTION OF THE DRAWINGS

FIG. 1 is a perspective view of a tire that includes one or more grooves having angled ribs.

FIG. 2 is an enlarged front plan view of a portion of the tire of FIG. 1.

FIG. 3 is a further enlarged view of a portion of a tread of a tire similar to that of FIGS. 1 and 2 with some of the tread features removed for ease of illustration.

FIG. 4 is another enlarged perspective view of a portion of a tread of a tire similar to that of FIGS. 1-3 with some of the tread features removed for ease of illustration.

FIG. 5 is a partial view of a sidewall and a portion of a tire groove that incorporates the angled ribs.

FIG. 6 is a plan view of the angled ribs along a sidewall of a tire groove.

### DETAILED DESCRIPTION

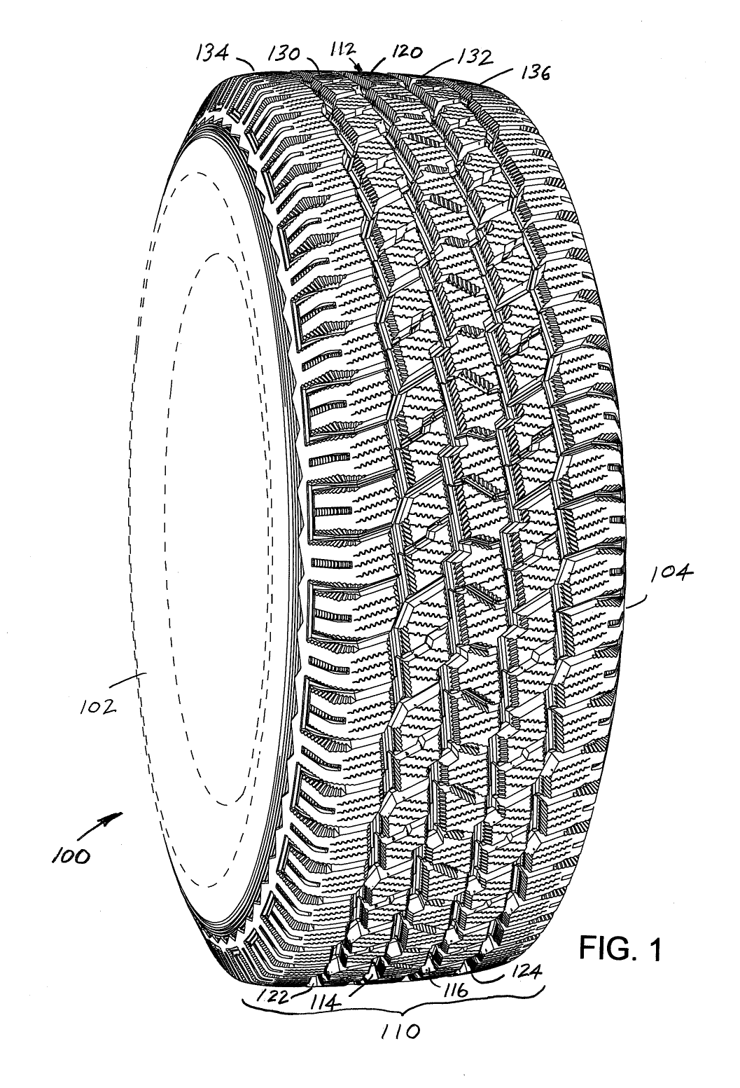

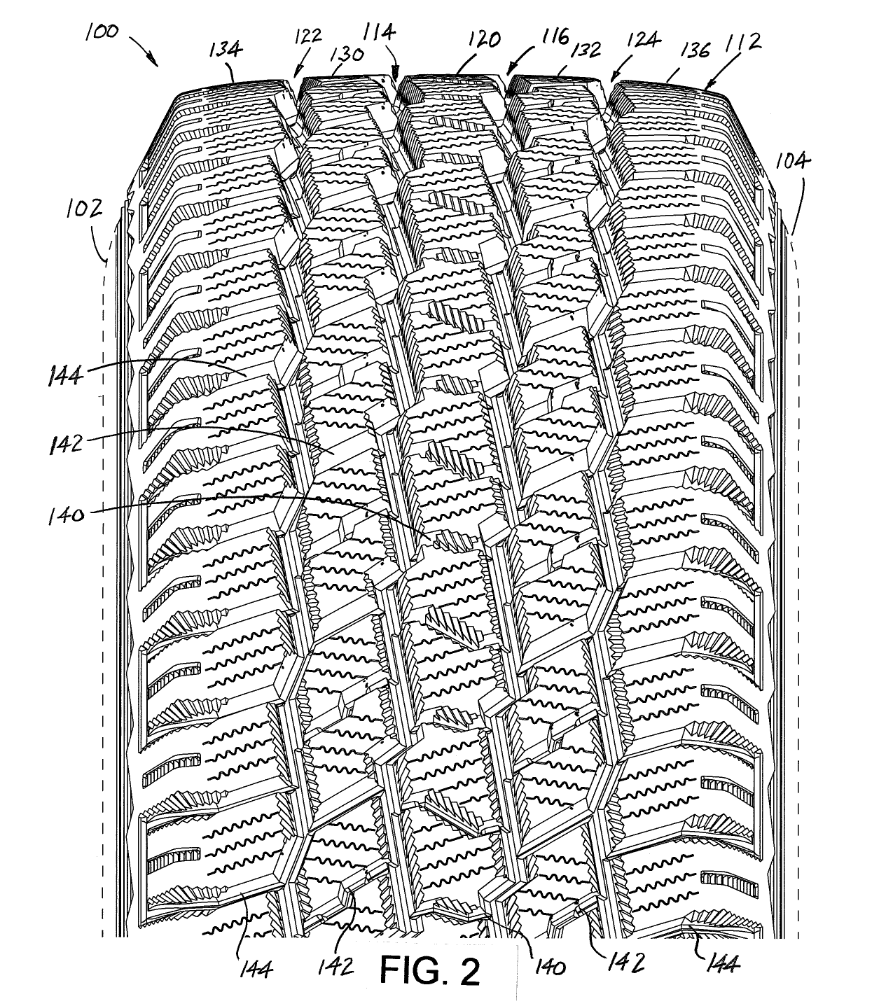

With reference to FIGS. 1 and 2, there is shown a pneumatic tire 100 that includes a first or outer side 102 (portions of the side being shown in broken line since those features are conventional and form no part of the present disclosure) and a second or inner side 104. A tire tread 110, typically an elastomeric material, is provided on the tire and extends between the first and second sides 102, 104. The tread 110 has a ground engaging surface 112 that is formed in a desired tread pattern through the incorporation of various grooves that extend in a generally circumferential direction around the tire and others that extend in a generally lateral direction across the tire.

More specifically, the tread 110 of the present disclosure includes first and second inner or central grooves 114, 116 extending in a generally circumferential direction around the tire and that form a central tread block 120 between them. In addition, first and second outer grooves 122, 124 extend in a generally circumferential direction around the tire 100 and together with the central grooves 114, 116 form intermediate tread block portions 130, 132. Likewise, the outer grooves 122, 124 divide the intermediate tread block portions 130, 132 from shoulder block portions 134, 136. The shoulder block portions 134, 136, in turn, are located between the outer grooves 122, 124 and the respective sides 102, 104 of the tire 100. The inner and outer grooves 114, 116, 122, 124 are generally equi-spaced in a lateral direction across the tire, although one skilled in the art will appreciate that the grooves need not necessarily be equally spaced in all applications of the present disclosure.

In addition, grooves 140 extend in a substantially lateral direction through the central tread block 120 and separate the central tread block into central tread block portions. Similarly, grooves 142 extend in a substantially lateral direction through the intermediate tread blocks 130, 132, and segregate the intermediate tread block into intermediate tread block portions, and likewise grooves 144 extend in a substantially lateral direction through the shoulder tread blocks 134, 136 to define shoulder tread block portions. As perhaps best illustrated in FIGS. 1 and 2, the different lateral grooves 140, 142, 144 are not aligned with one another in this embodiment but rather are offset from one another and form a zig-zag configuration proceeding from one side of the tire 100 to the other side. The same number of lateral grooves is provided through each of the central tread blocks 120, intermediate tread blocks 130, 132, and shoulder tread blocks 134, 136. One skilled in the art will appreciate, however, that the same number of lateral grooves need not necessarily be used in the center, intermediate, and shoulder rows of tread blocks in all applications of the present disclosure.

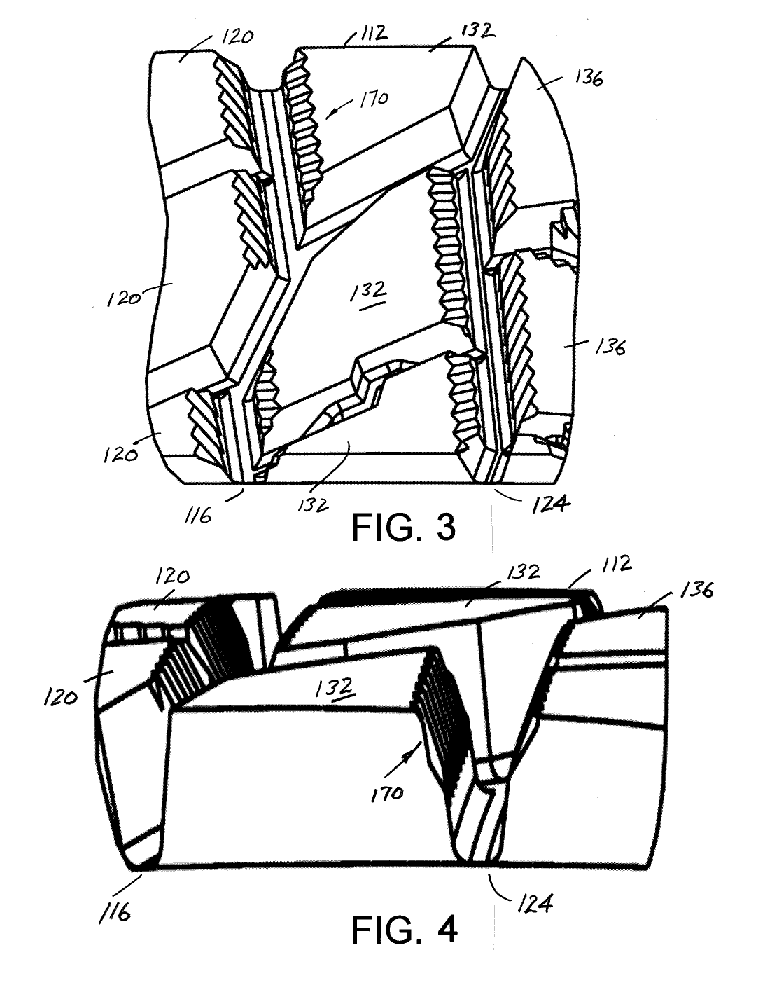

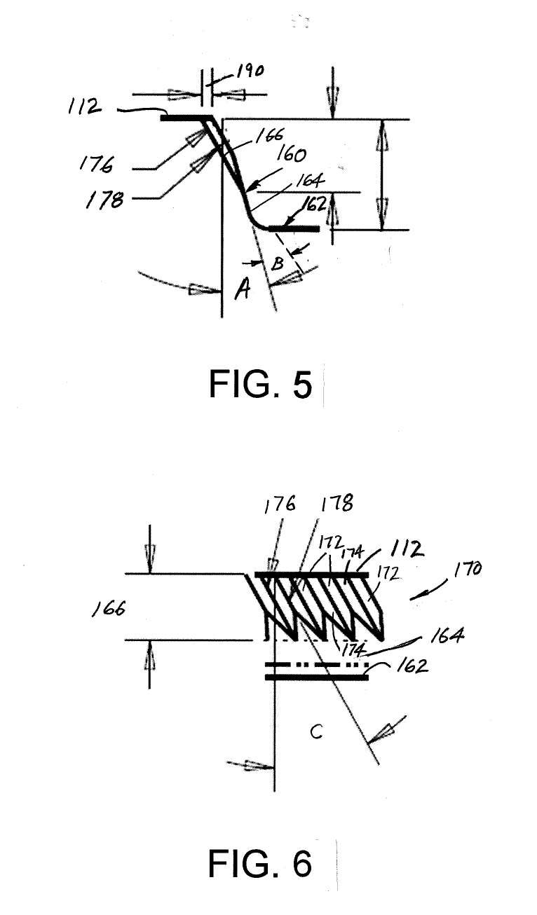

With continued reference to FIGS. 1 and 2, and additional reference to FIGS. 3-5, the different grooves 114, 116, 122, 124 (circumferentially extending grooves) and 140, 142, 144 (laterally extending grooves) have a generally U-shape formed by first and second sidewalls 160 and a bottom surface or base wall 162. The sidewalls 160 of a groove are disposed in generally facing relation, i.e. the sidewalls face one another across the void of the groove. As perhaps best illustrated in FIGS. 4 and 5, a first or lower portion 164 of the sidewall 160 extends outwardly from the bottom surface 162 of the groove at an angle A (the angle A being measured relative to perpendicular to the bottom surface 162 of the groove or perpendicular to the ground engaging surface 112 of the tread). It is contemplated that the angle A may range from 0° to 45°; preferably 5° to 20°; and more preferably 5° to 10°. In addition, a second or upper portion 166 of the sidewall 160 extends at an additional angle B. It is contemplated that the angle B may range from 0° to 45°; preferably 10° to 45°; and more preferably 25° to 30°.

At least some of the sidewalls 160, and as shown here the upper portions 166 of these sidewalls, include one or more serrations or ribs 170. The ribs are formed by angled faces 172, 174 that intersect in generally V-shapes to form alternating valleys 176 and peaks 178 (FIGS. 5 and 6). Further, the valleys 176 and peaks 178 are disposed at an angle C (FIG. 6) relative to normal. It is contemplated that the angle C may range from 1° to 89°; preferably 20° to 50°; and more preferably 30° to 45°. Still further, the angled ribs 170 on one sidewall are different and, in the exemplary embodiment, are opposed to the angled ribs on the other sidewall of the groove. That is, the same degree of angularity may or may not be used, however the angles C in the exemplary embodiment are opposite to one another on the two sidewalls 160 that together with a bottom surface 162 form a particular groove. It will also be appreciated that a height 190 of the ribs 170 may be varied depending on other parameters of the tire.

Still other rib shapes than the illustrated and above-described V-shaped ribs 172 can be used. For example, the ribs can be U-shaped which in some instances may be desirable since these ribs would provide less stress concentration at the valleys, etc. Similarly, the pitch may be varied, i.e., the distance between the adjacent peaks of the

V-shaped grooves or U-shaped grooves, may be varied for other design reasons such as noise. By way of example, a maximum range for pitch distance is 0.02″ to 0.5″; preferably from 0.07″ to 0.2″; and more preferably from 0.1″ to 0.15″. Exemplary groove widths may vary from about 0.05″ to about 1.00″, the groove depth may vary from about 0.10″ to about 1.00″, and the depth of the serrations 166 may range from 5% to 95% of the overall groove depth. The dimension 190 has a preferred range from about 0.1″ to 0.15″, and an intermediate range of 0.05″ to 0.2″. The depth 166 may range from 50-80% of the full groove depth, and more preferably from 60-75% of the full groove depth.

FIGS. 1-4 show some of the particular structural features of these ribs 170. For example, the first and second central grooves 114, 116 each include ribs 170 on both sidewalls 160 that are disposed in facing relation. As noted previously, the ribs 170 are preferably angled, namely, angle C shown in FIG. 6 (i.e., between 1° and 89°) from a plane extending perpendicular to the bottom surface 162 or perpendicular to the ground engaging surface 112 of the tread. As evident in FIGS. 1-3, the ribs 170 on the facing sidewalls 160 are opposite one another, i.e., the ribs angle in different directions. One rib on one sidewall is a positive angle C and the rib on the other sidewall is a negative angle C when measured relative to a plane that is perpendicular to the bottom wall 162 and perpendicular to the surface of each of the sidewalls 160.

FIGS. 1 and 2 also illustrate that the lateral grooves 140 include ribs 170 on the facing sidewalls 160 thereof. The ribs 170 on these facing sidewalls 160 are again angled in opposite directions. Thus, each of the central tread block portions 120 include ribs 170 in substantially surrounding relation about the central tread block portions. The ribs 170 extend over the upper portion 166 of each sidewall 160 and are angled outwardly as represented by the sum of angles A and B (FIG. 5). The ribs 170 extend over a majority of the longitudinal length of the sidewall 160 (where the longitudinal length is in defined in a direction that extends from left to right as viewed in FIG. 6).

The outer grooves 122, 124 are also shown to have ribs 170 disposed on both of the sidewalls 160 that face one another, and again in this arrangement the ribs are also disposed at opposite angles. Here, however, the intermediate tread blocks 130, 132 do not have ribs 170 along the lateral grooves 142. In other instances, it may be desirable to include ribs 170 along these lateral grooves, but in this exemplary embodiment the facing sidewalls 160 of the lateral grooves 142 in the intermediate tread blocks 130, 132 are devoid of any ribs.

Is also evident in FIGS. 1 and 2, that the grooves 142 in the shoulder tread block portions 134, 136 are also devoid of ribs along a first portion as the groove extends laterally from the outer groove 122, 124 toward the respective side 102, 104 of the tire. As the groove proceeds over the shoulder of the tire 100, however, ribs 180 are provided. In this particular exemplary embodiment, the ribs 180 in the outer ends of the lateral grooves 142 in the shoulder tread block portions are not arranged along an angle C as is the case with ribs 170 in other portions of the tire tread. Rather, ribs 180 are normal to the bottom surface 162 (i.e., angle C equals 0°).

In summary, winter or snow performance is improved. The angled ribs 170, particularly when used with opposing angles on opposite sidewalls 160 of the grooves, provide enhanced grabbing and holding of the snow in the tread pattern 110. This provides increased “snow on snow” traction. The angled ribs 170 provide an increase in surface area length than existing rib arrangements that contributes to improved mechanical locking with the snow rib that is formed when the angled rib snow grooves form within the contact patch. Moreover, the opposing angles on facing sidewalls of selected groups also provide better mechanical locking with the snow rib. This tread arrangement also increases the amount of snow traction from the mechanical shearing of the snow ribs formed in the angled rib snow grooves within the contact patch.

The serrations or ribs 170 are designed at an angle instead of being perpendicular to the tire surface (either the ground engaging surface 112 or the bottom surface 162 of the grooves). It will also be appreciated that the mold geometries required to create this tread 110 are rather complex and crowded. At select intersections of circumferentially extending and the laterally extending grooves, the ribs 170 along a particular sidewall 160 may not extend along the entire longitudinal length of the groove sidewall. In some instances, the lack of ribs 170 in select regions of the grooves can be advantageously used to aid in removing snow from the groove.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Moreover, this disclosure is intended to seek protection for a combination of components and/or steps and a combination of claims as originally presented for examination, as well as seek potential protection for other combinations of components and/or steps and combinations of claims during prosecution. It will also be appreciated that not all of the tread features such as all of the grooves, nor all of the ribs, etc. in the illustrated tire tread, have been identified by reference numerals for ease of illustration. However, similar features or components that are repeated in the tire tread design are structurally or functionally identical or equivalent to that described above unless particularly noted otherwise.

1. A pneumatic tire comprising:
first and second laterally spaced sides; and
a tread interposed between the first and second sides, the tread including a tread surface having at least one groove therein, the at least one groove including facing, first and second sidewalls separated by a groove bottom surface, and ribs extending over at least a portion of each of the first and second sidewalls and the ribs on at least one of the first and second sidewalls extend at a non-perpendicular angle relative to the tread surface, wherein the ribs on the first and second sidewalls of the groove are opposed to each other.

2. The tire of claim 1 wherein the ribs on both of the first and second sidewalls extend at a non-perpendicular angle relative to the tread surface.

3. The tire of claim 1 wherein the at least one groove extends in a substantially circumferential direction around the tire.

4. The tire of claim 1 wherein the at least one groove extends in a substantially lateral direction across the tire.

5. The tire of claim 1 wherein the ribs on at least one of the first and second sidewalls extend over only a portion thereof.

6. The tire of claim 5 wherein the ribs extend inwardly from the tread surface toward the bottom surface of the at least one groove and terminate on the sidewall at a groove depth spaced above the bottom surface.

7. The tire of claim 1 wherein the at least one groove includes one of first and second inner grooves forming a central tread block separated from first and second intermediate tread blocks where the inner grooves extend in a substantially circumferential direction around the tire.

8. The tire of claim 7 wherein the first and second intermediate tread blocks are spaced from first and second shoulder tread blocks by first and second outer grooves extending in a substantially circumferential direction around the tire, and wherein the first and second outer grooves are interposed between the first and second inner grooves and the first and second sides of the tire, respectively.

9. The tire of claim 1 wherein the ribs are generally defined by alternating peaks and valleys.

10. The tire of claim 9 wherein the ribs extend inwardly from the tread surface and terminate above a bottom surface of the groove.

11. The tire of claim 1 wherein the at least one groove includes one of first and second inner grooves forming a central tread block separated from first and second intermediate tread blocks where the inner grooves extend in a substantially circumferential direction around the tire, and each of the sidewalls of the central tread block includes ribs formed thereon.

12. The tire of claim 11 wherein the ribs on each of the sidewalls of the central tread block are disposed at substantially the same angle.

13. The tire of claim 12 wherein the first and second intermediate tread blocks include ribs only on sidewalls that extend in a substantially circumferential direction around the tire.

14. The tire of claim 13 wherein the first and second intermediate tread blocks include lateral grooves that extend in a substantially lateral direction across the tire, and sidewalls forming the lateral grooves of the intermediate tread blocks are devoid of ribs.

15. The tire of claim 11 wherein the central tread block includes lateral grooves that extend in a substantially lateral direction across the tire, and sidewalls forming the lateral grooves of the central tread blocks have ribs extending along at least a major portion thereof.

16. A pneumatic tire comprising:
first and second laterally spaced sides; and
a tread interposed between the first and second sides, the tread including a tread surface having at least one groove therein, the at least one groove including facing, first and second sidewalls separated by a groove bottom surface, and a series of serrations extending over at least a portion of a height of the facing sidewalls, wherein the serrations extend at a non-perpendicular angle relative to the tread surface and the serrations on the first and second sidewalls of the groove are opposed to each other.

17. The tire of claim 16 wherein the serrations alternate between adjacent peaks and valleys.

18. The tire of claim 17 wherein the adjacent peaks and valleys of the serrations generally form a V-shape in cross-section.

19. The tire of claim 16 wherein the serrations extend inwardly from the tread surface and only along a portion of the sidewalls.

20. The tire of claim 16 wherein the serrations are provided in each groove that forms a central tread block portion of the tread surface.
